(19) United States
(12) Patent Application Publication
(10) Pub. No.: US 2016/0012425 A1
(43) Pub. Date: Jan. 14, 2016

(54) Systems and Methods for Processing Transactions Between Customers and Merchants

(71) Applicant: MASTERCARD INTERNATIONAL INCORPORATED, Purchase, NY (US)

(72) Inventors: Ashutosh Sharan, Gurgaon (IN); Avyaktanand Tiwary, Gurgaon (IN); Jitender Balyan, Sydney (AU)

(21) Appl. No.: 14/791,911

(22) Filed: Jul. 6, 2015

(30) Foreign Application Priority Data
Jul. 9, 2014 (SG) 10201403973Y

(51) Int. Cl. G06Q 20/38

(52) U.S. Cl. CPC G06Q 20/38

(57) ABSTRACT

A method is provided. The method comprises obtaining transaction data of at least one transacting party, the at least one transacting party being one who has initiated a transaction with a first client, wherein at least one of the transaction data of the at least one transacting party relates to a transaction initiated by the at least one transacting party with a second client. Further, the method comprises determining a group of clients based on the transaction data of the at least one transacting party with one or more of the second clients to have clients that are different from each other. The method also comprises generating an indicia, using at least one of the clients in the group, that provides a likelihood that a holder of an account will initiate a transaction with the first client.

### FIELD

Various embodiments herein generally relate to a method and a corresponding server, computer-readable storage medium and computer program. In an embodiment, the method is one which provides a likelihood that a holder of an account, such as a consumer, initiates a transaction with an identified merchant.

### BACKGROUND

This section provides background information related to the present disclosure which is not necessarily prior art.

Merchants, advertising companies and financial institutions are interested in understanding consumer spending habits. Particularly, these business entities are interested to find out if a consumer is likely to transact with a merchant. This will allow these business entities to effectively present their promotions to the correct group of consumers. Also, this allows the merchants to be prepared in the event that an increase of sales is expected in the near future.

As such, resources are invested to identify and predict a consumer's interest. In order to do so, great effort has been taken to identify and categorize a consumer's interest.

Conventional means of determining a consumer's interest have generally relied on collecting past transaction data belonging to a consumer so as to analyze a consumer's past spending habits. By doing so, it is possible to find out the different industries that the consumer has decided to spend at and the amount that the consumer has spent at each industry. One of the problems of these conventional means is that they tend to provide analysis on the consumer's past transaction at an industry level, without providing a prediction of a consumer's future interest.

In other words, this is a relatively poor indicator of what the consumer's spending patterns will be in the future. For example, it is not possible to find out if the consumer is likely to spend at a certain merchant in the future.

Another problem of these conventional means is that if a consumer has not previously spent in an industry under which a particular merchant is categorized, it is impossible to find out if the consumer is likely to spend at this merchant in the future. For example, if a consumer has not performed any transactions in the automobile industry, it is impossible to find out if he/she will transact with a certain automobile merchant since his/her past transaction data will not provide any information of his/her interest in the automobile industry.

In view of the above, it would be desirable to find out the likelihood that a consumer is likely to transact with a merchant.

### SUMMARY

This section provides a general summary of the disclosure, and is not a comprehensive disclosure of its full scope or all of its features. Aspects and embodiments of the disclosure are also set out in the accompanying claims.

Various embodiments provide a method comprising obtaining transaction data of at least one transacting party, the at least one transacting party being one who has initiated a transaction with a first client, wherein at least one of the transaction data of the at least one transacting party relates to a transaction initiated by the at least one transacting party with a second client; determining a group of clients based on the transaction data of the at least one transacting party with one or more of the second clients to have clients that are different from each other; and generating an indicia, using at least one of the clients in the group, that provides a likelihood that a holder of an account will initiate a transaction with the first client. In an embodiment, the holder of the account is the at least one transacting party who has initiated a transaction with the first client.

In an embodiment, the holder of the account is one other than the at least one transacting party who has initiated a transaction with the first client.

In an embodiment, at least one of the transaction data of the at least one transacting party relates to a transaction initiated by the at least one transacting party with the first client, wherein determining the group of clients is also based on transaction data of the at least one transacting party with the first client.

In an embodiment, the indicia is generated based on the transaction data of the holder of the account over a time period.

In an embodiment, the indicia indicates if the holder of the account is likely to initiate a transaction with the first client for a future time period.

In an embodiment, the method further comprising generating another indicia based on transaction data of a holder of another account, the other indicia indicating if the holder of another account is likely to initiate a transaction with the first client.

In an embodiment, the method further comprises ranking the holders of the accounts based on both the generated indicia.

In an embodiment, determining the group of clients based on the transaction data of the at least one transacting party further comprises obtaining transaction data of a plurality of holders of accounts in a database, each of the transaction data of the plurality of holders of accounts relating to a transaction initiated by a holder of an account with a client; generating a group of clients based on the transaction data of the plurality of holders of accounts; and removing at least one client from the generated group of clients, based on a filtering criteria applied on the transaction data of the plurality of holders, so that the remaining clients are used to generate the indicia that provides the likelihood that a holder of an account will initiate a transaction with the first client.

In an embodiment, the filtering criteria applied on the transaction data of the plurality of holders comprises determining if a client, related to the transaction data of the plurality of holders of accounts, belongs to a group of clients with which a number of holders of accounts transact, the number being one which is above a threshold.

In an embodiment, the threshold is a predetermined portion of the plurality of holders of accounts in the database.

In an embodiment, the method further comprises determining a number of the accounts in the database who will transact with the first client.

In an embodiment, at least one of the transaction data of the at least one transacting party relates to a transaction initiated by the at least one transacting party with each of a plurality of clients that are different from the first client.

In an embodiment, the first and second clients are merchants and the at least one transacting party is a customer who initiates the transaction with the merchants.

In an embodiment, the transaction is a payment transaction between the first or second client and the at least one transacting party.

Various embodiments provide a server comprising at least one processor; and at least one memory including computer program code; the at least one memory and the computer program code configured to, with the at least one processor, cause the server at least to: obtain transaction data of at least one transacting party, the at least one transacting party being one who has initiated a transaction with a first client, wherein at least one of the transaction data of the at least one transacting party relates to a transaction initiated by the at least one transacting party with a second client to have clients that are different from each other; determine a group of clients based on the transaction data of the at least one transacting party with one or more of the second client; and generate an indicia, using at least one of the clients in the group, that provides a likelihood that a holder of an account will initiate a transaction with the first client.

Various embodiments provide a server comprising means for obtaining transaction data of at least one transacting party, the at least one transacting party being one who has initiated a transaction with a first client, wherein at least one of the transaction data of the at least one transacting party relates to a transaction initiated by the at least one transacting party with a second client; means for determining a group of clients based on the transaction data of the at least one transacting party with one or more of the second clients to have clients that are different from each other; and means for generating an indicia, using at least one of the clients in the group, that provides a likelihood that a holder of an account will initiate a transaction with the first client.

Various embodiments provide a computer-readable storage medium having stored thereon computer program code which when executed by a computer causes the computer to execute a method in accordance with an embodiment.

Various embodiments provide a computer program comprising software code adapted to perform a method in accordance with an embodiment.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Example embodiments of the disclosure will be better understood and readily apparent to one of ordinary skill in the art from the following written description, by way of example only, and in conjunction with the drawings, in which:

FIGS. 1(a) to 1(c) collectively depict associations and relationships between customers and merchants relevant to embodiments of the present disclosure when used by a transacting party;

FIG. 2 is a block diagram of a system within which embodiments of the present disclosure may be performed;

FIG. 3 is a schematic diagram of a wireless device which may be used in FIG. 2;

FIG. 4 is a schematic diagram of a computer system within which embodiments of the present disclosure may be performed;

FIG. 5 is a flow diagram illustrating a method in accordance with an embodiment of the present disclosure;

FIG. 6 is a flow diagram illustrating a method in accordance with another embodiment of the present disclosure; and

FIG. 7 is a graphical representation of a number of affinity merchants against the number of inactive customers during a time period.

### DETAILED DESCRIPTION

Embodiments will be described, by way of example only, with reference to the drawings. Like reference numerals and characters in the drawings refer to like elements or equivalents.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “scanning”, “calculating”, “determining”, “replacing”, “generating”, “initializing”, “outputting”, “establishing”, “receiving”, “sending”, “identifying”, “transmitting”, “comparing”, “extracting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program and the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer-readable medium. The computer-readable medium may include storage devices such as magnetic or optical disks, memory chips, or other storage devices suitable for interfacing with a general purpose computer. The computer-readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of a method in accordance with an embodiment of the disclosure.

The disclosure may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Various embodiments relate to a method and a corresponding server, computer-readable storage medium and computer program. In an embodiment, the method is one which that provides a likelihood that a holder of an account will initiate a transaction with an identified client.

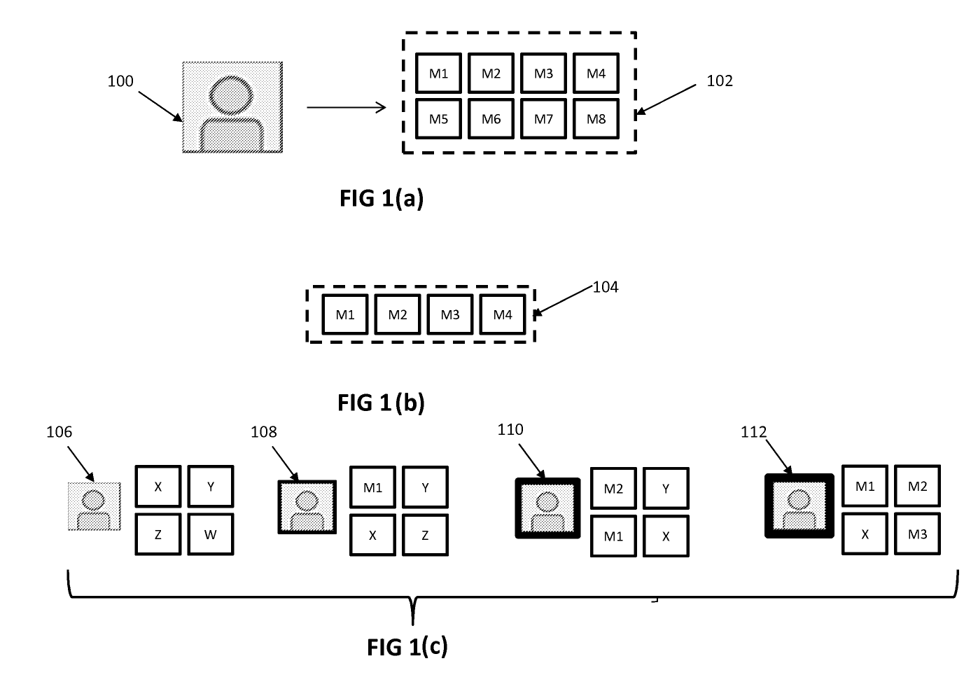

With reference to FIG. 1(a), a transacting party 100 with a plurality of clients 102 is shown. The transacting party is a customer who initiates the transaction with at least one client. The client is typically a merchant who is a party to the transaction. For example, the customer may initiate the transaction with the merchant to buy goods and/or services from the merchant. The transaction is generally a payment transaction. In other words, completion of the transaction between the customer and the merchant involves a payment between parties to the transaction. The customer is generally a holder of an account via which the transaction may be at least partly performed, such as financially settled.

In the description which follows, the terms “customer” and “merchant” will be used. However, it is to be understood that in various embodiments, these terms could be respectively interchanged with “transacting party” and “client”.

FIG. 1(a) shows that the customer initiates transactions with a plurality of merchants M1-M8 over a time period. The merchants M1-M8 may be categorized under the same or different industries. Within this plurality of merchants, one of them will be identified (for example, M8) to find the likelihood that a transaction will be performed with that identified merchant. FIG. 1(b) shows that a group of merchants 104, such as M1-M4, may be determined in order to find the above likelihood. In this example, the group of merchants 104 are affinity merchants to an identified merchant, such as the merchant M8 from FIG. 1(a). An affinity merchant is one, amongst several merchants, with which a holder of an account has transacted where the holder of the account has also transacted with the identified merchant. As such, an affinity merchant is relevant to determining a likelihood that a holder of any account may initiate a transaction with the identified merchant, M8 in this case.

FIG. 1(c) shows that the more affinity merchants M1-M4 (from the group of merchants 104 of FIG. 1(b)) that a holder of an account (account owner) 106 transacts with, the more likely he/she will transact with the identified client. The holder of the account 106 may be a customer of the identified merchant or someone who has not transacted with the identified merchant before. FIG. 1(c) specifically shows a number of customers 106, 108, 110 and 112 and various merchants with which each has previously transacted. Each of the customers 106, 108, 110 and 112 is holder of a respective transaction account and, as seen, the customer 106 has transacted with merchants W, X, Y and Z. Customer 108 has previously transacted with merchants M1, X, Y and Z. Customer 110 has transacted with merchants M1, M2, X and Y, and customer 112 has transacted with merchants X, M1, M2 and M3. It will be appreciated from FIG. 1(c) that each of the customers 108, 110 and 112 have transacted with one or more of the merchants of the group of merchants 104 from FIG. 1(b). However, the customer 106 is seen not to have previously transacted with any merchant from the group 104, but nevertheless has transacted with some merchants with which at least one of customers 108, 110 and 112 had previously transacted.

It follows from FIGS. 1(a)-1(c) that based on the overlap of merchants seen in FIGS. 1(b) and 1(c) i.e., the number of affinity merchants (M1-M4) 104 that a customer has spent at, it would be desirable to show how likely a customer 106, 108, 110 or 110 may spend at the identified merchant, M8 in this case.

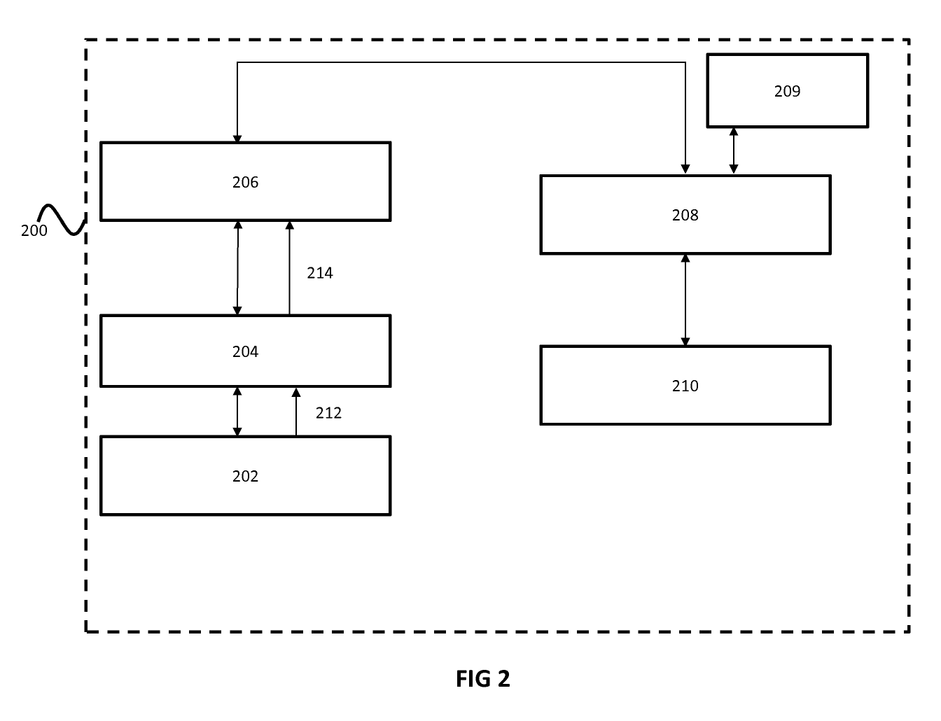

FIG. 2 illustrates a block diagram of a transaction system within which embodiments of the present disclosure may be performed. The system 200 illustrates elements that may be utilized to perform processes relating to a transaction between a customer and a merchant.

The system 200 comprises a transacting party device 202 in communication with a client device 204. The transacting party device is typically a customer device and the client device is typically a merchant device. In the description which follows, the terms “customer device” and “merchant device” will be used.

The merchant device 204 is in communication with an acquirer server 206. The acquirer server 206 is in communication with a payment network server 208. The payment network server 208 is in communication with an issuer server 210.

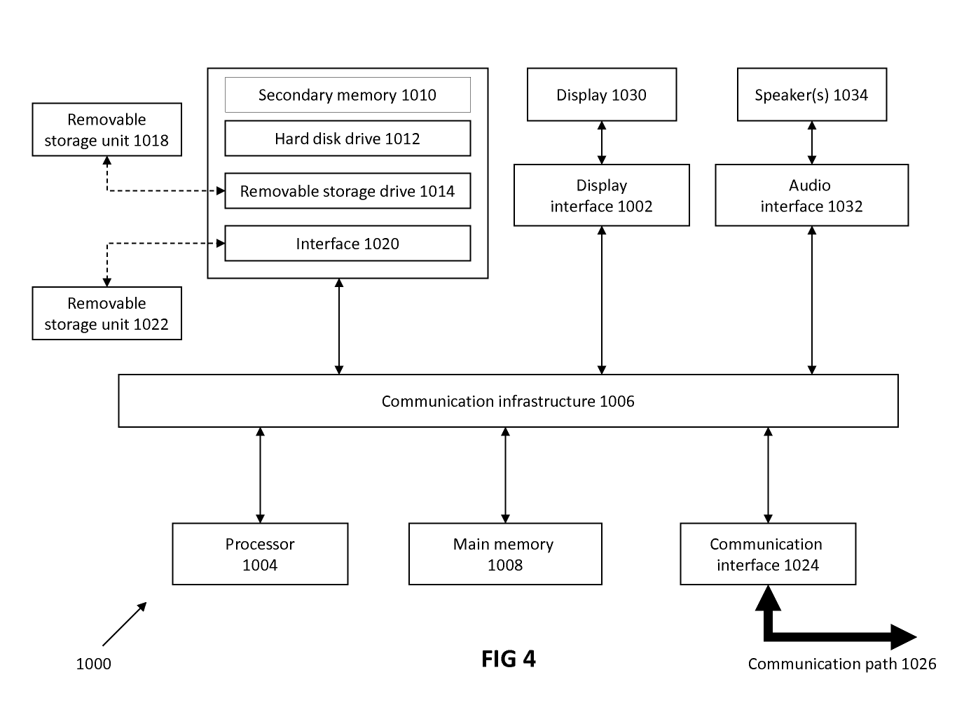

Use of the term ‘server’ herein may be understood to mean a single computing device or a plurality of interconnected computing devices which operate together to perform a particular function. That is, the server may be contained within a single hardware unit or be distributed among several or many different hardware units. An exemplary computing device which may be operated as a server is described below with reference to FIG. 4.

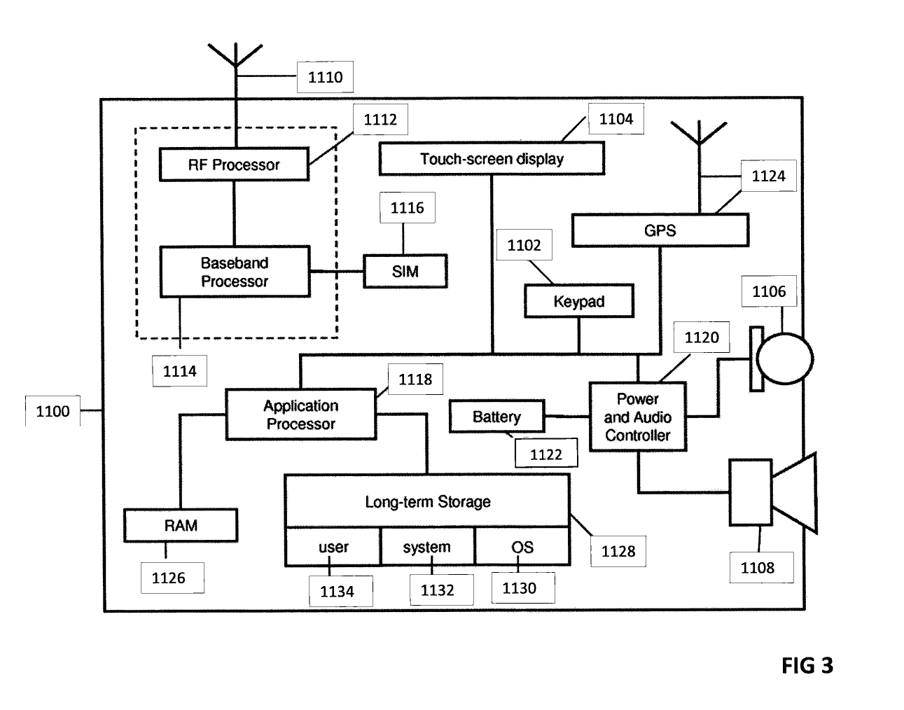

The customer device 202 is typically associated with the customer who is a party to the transaction. The customer device 202 may be a fixed (wired) computing device or a wireless (portable) computing device. In specific implementations, the customer device 202 may be a handheld or portable or mobile device carried or used by the customer, or may refer to other types of electronic devices such as a personal computer, a land-line telephone, an interactive voice response (IVR) system, and the like. The mobile device may be a device, such as a mobile phone, a laptop computer, a personal digital computer (PDA), a mobile computer, a portable music player (such as an iPod™ and the like). An exemplary wireless computing device is described below with reference to FIG. 3.

The merchant device 204 is typically associated with the merchant who is also a party to the transaction. The merchant device 204 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The acquirer server 206 is generally associated with an acquirer who may be an entity (e.g. a company or organization) which issues (e.g. establishes, manages, administers) an account (e.g. a financial bank account) of the merchant. Examples of the acquirer include a bank and/or other financial institution. As foreshadowed above, the acquirer server 206 may include one or more computing devices that are used to establish communication with another server by exchanging messages with and/or passing information to the other server.

The payment network server 208 is typically associated with a payment facilitator. For example, the payment network server 208 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 208 may include one or more computing devices that are used for processing transactions.

The issuer server 210 is generally associated with an issuer and may include one or more computing devices that are used to perform a payment transaction. The issuer may be an entity (e.g. a company or organization) which issues (e.g. establishes, manages, administers) an account (e.g. a financial bank account) of an account holder or an account owner.

In an embodiment of the disclosure, the payment network server 208 may be configured to communicate with, or may include, a database 209. The database 209 stores data corresponding to each account issued by the issuer. Examples of the data include a password, an account holder name and address, a credit limit and transaction data relating to one or more transactions performed by the account holder on the account. In some embodiments of the disclosure, at least one of the transaction data may relate to a transaction initiated by the customer with a plurality of merchants that are different from the identified merchant.

In an example, during a transaction, a transaction request message 212 is generated at the customer device 202. The transaction request message 212 is generated by the customer device 202 in response to the customer making a selection of a good and/or service to be purchased from the merchant. Therefore, the transaction request message relates to a transaction between the customer and the merchant. In specific implementations, the transaction may be performed via a website of the merchant.

The transaction request message 212 may include transaction data and/or data relating to the customer (i.e. customer data). Each transaction data relates to a transaction and identifies the customer and the merchant, generally by way of account identifiers of each associated with the issuer and acquirer respectively. Further, the transaction data may also identify the goods and/or services to be purchased. The transaction data may further identify a value or price of the goods and/or services. The transaction data may also indicate a time and date at which the transaction was initiated.

The transaction request message 212 is sent from the customer device 202 to the merchant device 204. In an embodiment of the disclosure, for example, where the transaction is being performed at the website of the merchant, the customer device 202 and the merchant device 204 are in communication with a network, such as, the Internet (not shown for the sake of simplicity). In this example, the transaction request message 212 is sent from the customer device 202 to the merchant device 204 via the network.

A request message 214 may be generated at the merchant device 204 which acts to request the issuer to authorize or perform the transaction. In an embodiment of the disclosure, the request message 214 is a payment request message or a modified transaction request message. In an embodiment of the disclosure, the transaction is done via the Internet and the request message 214 may include merchant data. The merchant data may indicate the address of the merchant's website and/or the type of the transaction.

The request message 214 is sent from the merchant device 204 to the acquirer server 206. The request message 214 includes the transaction data and thus identifies the customer and the merchant. The transaction data in the request message 214 may serve as a request for the issuer to authorize the transaction. In other words, the acquirer server 206 may be permitted to obtain the transaction amount on behalf of the merchant.

The request message 214 is forwarded (not illustrated) from the acquirer server 206 to the payment network server 208. In an embodiment of the disclosure, the acquirer server 206 may not conduct any processing on or with the request message 214 and, instead, may merely receive the request message 214 from the merchant device 204 and forward it to the payment network server 208.

The request message 214 is received at the payment network server 208. In this way, the payment network server 208 is informed of the transaction and that the merchant would like to obtain authorization of the transaction. In an embodiment of the disclosure, the payment network server 208 stores the request message 214 in the database 209. In this manner, transaction data of a customer may be stored in the database 209.

As mentioned above, the role of the payment network server 208 is to facilitate communication between the acquirer server 206 and the issuer server 210. Therefore, the payment network server 208 may serve as a means through which the acquirer server 206 may communicate with the issuer server 210 in order that payments and authentication may be performed. In a similar fashion, the payment network server 208 may be informed of every transaction between the acquirer server 206 and the issuer server 210.

It follows from the above that the payment network server 208, and more particularly the database 209, form a repository of transaction data for many customers and many merchants.

FIG. 3 is a schematic of an exemplary wireless computing device 1100 that may be utilized to implement the customer device (such as 202 in FIG. 2) and/or the merchant device (such as 204 in FIG. 2).

The wireless device 1100 comprises a keypad 1102, a touch-screen 1104, a microphone 1106, a speaker 1108 and an antenna 1110. The wireless device 1100 is capable of being operated by a user to perform a variety of different functions, such as, for example, hosting a telephone call, sending an SMS message, browsing the Internet, sending an email and providing satellite navigation.

The wireless device 1100 comprises hardware to perform communication functions (e.g. telephony, data communication), together with an application processor and corresponding support hardware to enable the wireless device 1100 to have other functions, such as, messaging, Internet browsing, email functions and the like. The communication hardware is represented by the RF processor 1112 which provides an RF signal to the antenna 1110 for the transmission of data signals, and the receipt therefrom. Additionally provided is a baseband processor 1114, which provides signals to and receives signals from the RF Processor 1112. The baseband processor 1114 also interacts with a subscriber identity module 1116, as is well known in the art. The communication subsystem enables the wireless device 1100 to communicate via a number of different communication protocols including 3G, 4G, GSM, WiFi, Bluetooth™ and/or CDMA. The communication subsystem of the wireless device 1100 is beyond the scope of the present disclosure.

The keypad 1102 and the touch-screen 1104 are controlled by an application processor 1118. A power and audio controller 1120 is provided to supply power from a battery 1122 to the communication subsystem, the application processor 1118, and the other hardware. The power and audio controller 1120 also controls input from the microphone 1106, and audio output via the speaker 1108. Also provided is a global positioning system (GPS) antenna and associated receiver element 1124 which is controlled by the application processor 1118 and is capable of receiving a GPS signal for use with a satellite navigation functionality of the wireless device 1100.

In order for the application processor 1118 to operate, various different types of memory are provided. Firstly, the wireless device 1100 includes Random Access Memory (RAM) 1126 connected to the application processor 1118 into which data and program code can be written and read from at will. Code placed anywhere in RAM 1126 can be executed by the application processor 1118 from the RAM 1126. RAM 1126 represents a volatile memory of the wireless device 1100.

Secondly, the wireless device 1100 is provided with a long-term storage 1128 connected to the application processor 1118. The long-term storage 1128 comprises three partitions, an operating system (OS) partition 1130, a system partition 1132 and a user partition 1134. The long-term storage 1128 represents a non-volatile memory of the wireless device 1100.

In the present example, the OS partition 1130 contains the firmware of the wireless device 1100 which includes an operating system. Other computer programs may also be stored on the long-term storage 1128, such as application programs, and the like. In particular, application programs which are mandatory to the wireless device 1100, such as, in the case of a smartphone, communications applications and the like are typically stored in the system partition 1132. The application programs stored on the system partition 1132 would typically be those which are bundled with the wireless device 1100 by the device manufacturer when the wireless device 1100 is first sold.

Application programs which are added to the wireless device 1100 by the user would usually be stored in the user partition 1134.

As stated, the representation of FIG. 3 is schematic. In practice, the various functional components illustrated may be substituted into one and the same component. For example, the long-term storage 1128 may comprise NAND flash, NOR flash, a hard disk drive or a combination of these.

FIG. 4 depicts an exemplary computing device 1000 where one or more such computing devices 1000 may be used for the acquirer server 206, the payment network server 208 or the issuer server 210. The following description of the computing device 1000 is provided by way of example only and is not intended to be limiting.

As shown in FIG. 4, the example computing device 1000 includes a processor 1004 for executing software routines. Although a single processor is shown for the sake of clarity, the computing device 1000 may also include a multi-processor system. The processor 1004 is connected to a communication infrastructure 1006 for communication with other components of the computing device 1000. The communication infrastructure 1006 may include, for example, a communications bus, cross-bar, or network.

The computing device 1000 further includes a main memory 1008, such as a random access memory (RAM), and a secondary memory 1010. The secondary memory 1010 may include, for example, a hard disk drive 1012 and/or a removable storage drive 1014, which may include a floppy disk drive, a magnetic tape drive, an optical disk drive, or the like. The removable storage drive 1014 reads from and/or writes to a removable storage unit 1018 in a well-known manner. The removable storage unit 1018 may include a floppy disk, magnetic tape, optical disk, or the like, which is read by and written to removable storage drive 1014. As will be appreciated by persons skilled in the relevant art(s), the removable storage unit 1018 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1020. Examples of a removable storage unit 1022 and interface 1020 include a program cartridge and cartridge interface (such as that found in video game console devices), a removable memory chip (such as an EPROM or PROM) and associated socket, and other removable storage units 1022 and interfaces 1020 which allow software and data to be transferred from the removable storage unit 1022 to the computer system 1000.

The computing device 1000 also includes at least one communication interface 1024. The communication interface 1024 allows software and data to be transferred between computing device 1000 and external devices via a communication path 1026. In various embodiments of the disclosures, the communication interface 1024 permits data to be transferred between the computing device 1000 and a data communication network, such as a public data or private data communication network. The communication interface 1024 may be used to exchange data between different computing devices 1000 which such computing devices 1000 form part of an interconnected computer network. Examples of a communication interface 1024 can include a modem, a network interface (such as an Ethernet card), a communication port, an antenna with associated circuitry and the like. The communication interface 1024 may be wired or may be wireless. Software and data transferred via the communication interface 1024 are in the form of signals which can be electronic, electromagnetic, optical or other signals capable of being received by communication interface 1024. These signals are provided to the communication interface 1024 via the communication path 1026.

As shown in FIG. 4, the computing device 1000 further includes a display interface 1002 which performs operations for rendering images to an associated display 1030 and an audio interface 1032 for performing operations for playing audio content via associated speaker(s) 1034.

As used herein, the term “computer program product” may refer, in part, to removable storage unit 1018, removable storage unit 1022, a hard disk installed in hard disk drive 1012, or a carrier wave carrying software over communication path 1026 (wireless link or cable) to communication interface 1024. A computer readable medium can include magnetic media, optical media, or other recordable media, or media that transmits a carrier wave or other signal. These computer program products are devices for providing software to the computing device 1000.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1004 to perform features of the above-described embodiments. Accordingly, such computer programs represent controllers of the computer system 1000.

Software may be stored in a computer program product and loaded into the computing device 1000 using the removable storage drive 1014, the hard disk drive 1012, or the interface 1020. Alternatively, the computer program product may be downloaded to the computer system 1000 over the communications path 1026. The software, when executed by the processor 1004, causes the computing device 1000 to perform functions of embodiments described herein.

It is to be understood that the embodiment of FIG. 4 is presented merely by way of example. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts.

It will be appreciated that the elements illustrated in FIG. 4 function to provide means for performing the various functions and operations of the servers as described in the above embodiments.

In an implementation, the payment network server 208 may be generally described as a physical device comprising at least one processor and at least one memory including computer program code. The at least one memory and the computer program code are configured to, with the at least one processor, cause the physical device to perform the operations below.

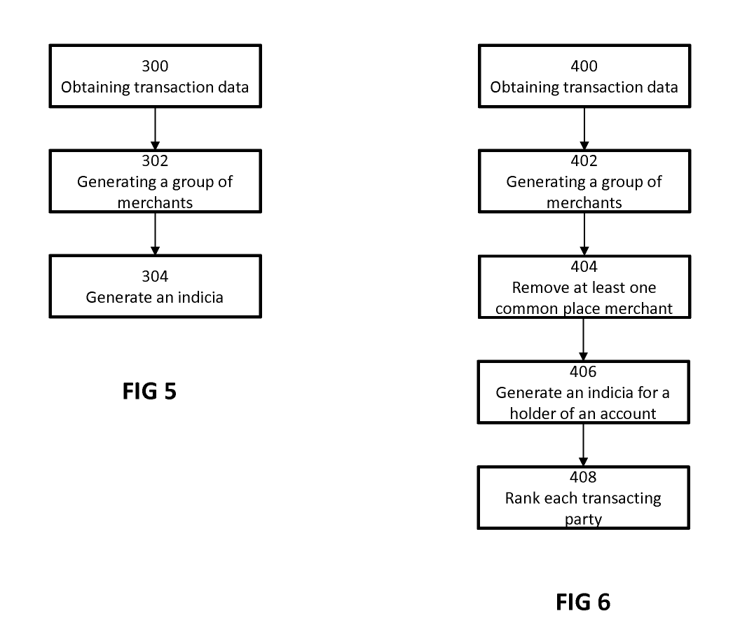

For example, either of the methods of the following FIGS. 5 and 6 may be implemented as software and stored in a non-transitory fashion in the secondary memory 1010 or the removable storage units 1018, 1022 of the computer device 1000. Further details on the method shown in FIGS. 5 and 6 are described below.

FIG. 5 shows flow diagram of a method performed by at least one of the above-described elements (as described in FIG. 2) in accordance with a first embodiment of the disclosure. In the first embodiment of the disclosure, the method aims to ascertain a likelihood, by determining a likelihood measure, that a holder of an account, such as a consumer, will initiate a transaction with an identified merchant. The flow diagram is now described with reference to FIG. 2.

In FIG. 5, processing begins at operation 300. At operation 300, transaction data is obtained from the database 209. A first client is an identified merchant who initiates a campaign (promotion or advertisement) with the third party (such as MasterCard®). In the description which follows, the term “identified merchant” will be used.

Transaction data of at least one customer of the identified merchant is obtained from the database 209. The transaction data relates to the transactions initiated by the customer. The transaction data may refer to transactions between the customer and (i) the identified merchant or (ii) a second client (i.e., a merchant who is not the identified merchant).

In an example, a merchant, AA may approach a payment facilitator to indicate an interest in finding out the likelihood of a person making a purchase from them. In this manner, the payment facilitator is informed of a particular merchant and may identify this particular merchant (i.e., AA) to its payment network server 208. The payment network server 208 may then obtain past transaction data belonging to at least one customer of AA. In an alternative implementation, the payment network server 208 may obtain past transaction data belonging to two or more customers of AA.

At operation 302, a group of merchants (or affinity merchants) are determined at the payment network server 208 based on the transaction data of the customer. In a specific implementation of the operation 302, filtering criteria may be applied to the group of merchants to select merchants which are relevant to determining a likelihood that a holder of an account may initiate a transaction with the identified client. In other words, the group of merchants shares an affinity with the identified merchant.

By way of example, a customer, Mary, who has previously transacted with an identified merchant, AA, also spent at other merchants. The other merchants are BB, CC, DD and EE.

A filtering criteria may be applied to these other merchants. Subsequent to applying the filtering criteria, a group of merchants, e.g. BB and CC, may be determined. The group of merchants are seen to share an affinity with the identified merchant. In other words, customers who spend at any one of this group of merchants (in this instance, BB and CC) may be likely to spend at AA.

As mentioned in the above, each of the transaction data relates to one transaction between the customer and a merchant. The group of merchants may or may not include the identified merchant.

By way of example, the payment network server 208 may be configured to process the transaction data to determine a group of merchants with which the customers has initiated transactions.

At operation 304, an indicia is generated. The indicia is generated using at least one of the merchants in the group determined at operation 302. The indicia provides a likelihood that a holder of an account may initiate a transaction with the identified merchant. In an embodiment of the disclosure, the indicia may be generated based on the number of affinity merchants in the group with which the customer has transacted.

By way of example, a customer who has transacted with only one merchant in the group will generate a first indicia and another customer who has transacted with two merchants in the group will generate a second indicia. The first indicia may be smaller than the second indicia. In other words, the first and second indicia indicate the number of merchants with which the corresponding customer has transacted.

As mentioned above, the group of merchants is relevant to determining a likelihood that a holder of an account may initiate a transaction with the identified client. Therefore, the generated first and second indicia provide a likelihood that a holder of an account will initiate a transaction with the identified merchant.

FIG. 6 shows flow diagram of a method performed by at least one of the above-described elements in accordance with another embodiment of the disclosure. The flow diagram is now described with reference to FIG. 2.

At operation 400, transaction data belonging to some or all of the holders of accounts are obtained from a database. Each of these transaction data relates to a transaction initiated by a holder of an account with a client. Accordingly, operation 400 of FIG. 6 may be analogous to operation 300 of FIG. 5.

At operation 402, a group of merchants is generated based on the transaction data belonging to the holders of accounts in the database 209. In an implementation, an account (e.g. credit account, debit account, pre-paid account) is issued by an issuer pursuant to the MasterCard® International Incorporated rules. Further, the group of merchants include merchants whom the holders of accounts have prior transactions. This group of merchants may or may not include the identified merchant.

At operation 404, at least one merchant from the generated group of merchants is removed based on a filtering criteria applied on the transaction data of the plurality of holders. The filtering criteria removes common place merchants from the group of merchants generated at operation 402. That is, each merchant in the group of merchants may be a common place merchant or a non-common-place merchant. A common place merchant is a merchant with which holders of accounts above a threshold have transacted. The threshold may be a percentage of the total number of accounts in a database. Examples of a common place merchant may include supermarket chains, department stores, fast food chains, etc.

The remaining merchants in the group of merchants are merchants which are relevant to the identified merchant. As such, removing common place merchants typically identifies affinity merchants which are relevant to determining a likelihood that a holder of an account may initiate a transaction with the identified client. Advantageously, removing common place merchants so as to determine the group of affinity merchants may be used to provide a likelihood that a holder of an account will initiate a transaction with an identified merchant, even when the holder of an account has not performed prior transactions with the identified merchant. This is possible because the likelihood is determined based on the transaction data relating to transactions with the group of affinity merchants.

At operation 406, an indicia is generated for one holder of an account. In an embodiment of the disclosure, more than one indicia is generated. Each indicia corresponds to one holder of an account. Accordingly, operation 406 of FIG. 6 may be analogous to operation 304 of FIG. 5.

At operation 408, each holder of the account is ranked based on the indicia generated at operation 406. In an implementation, the ranking of the holders of the accounts may also be based on their financial credibility (e.g. outstanding bills and/or credit history). Alternatively, the ranking of the holders of the accounts may be based on the account's “open to buy” limit (credit account).

The software stored in the secondary memory 1010 is read and executed by the processor 1004 to perform the methods to generate indicia and/or rank the transacting parties.

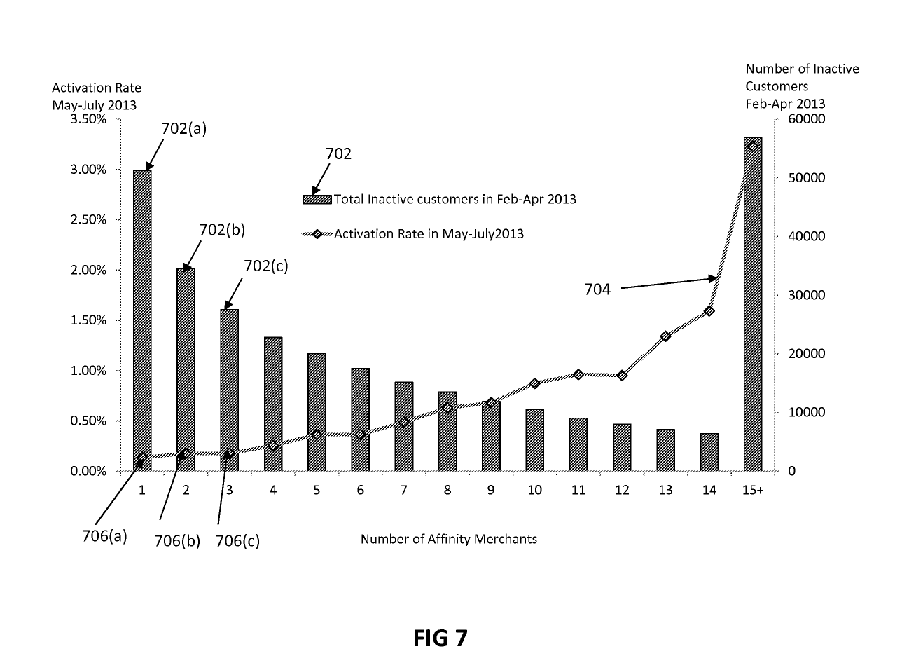

FIG. 7 shows a graph of a number of affinity merchants (horizontal scale) against the number of inactive customers (right vertical scale) during a time period. Either of the methods shown in FIGS. 5 and 6 may be used to find out the number of inactive customers who spend at a specific number of affinity merchants in the last 3 months. Accordingly, an activation rate which is indicative of a likelihood of the number of people that may spend at the identified merchant in a future time period, will be tabulated.

Each of the bars 702 denotes the number of inactive customers who spend at a specific number of affinity merchants in the last 3 months, February to April 2013 in this case. For example, about 52,000 customers spent at one affinity merchant in February to April 2013.

Line 704 is constructed from joining markers 706, which are each derived from a respective bar 702 (for example marker 704(a) is derived from bar 702(a). Line 704 denotes an activation rate in the next 3 months based on a respective bar 702. Following the above example, the activation rate based on the above 52,000 customers is about 0.01%.

As it can be seen from FIG. 7, when more inactive customers spend at more affinity merchants, the activation rate increases.

It should be appreciated that the functions and/or steps and/or operations described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

It should further be appreciated that the exemplary embodiments are only examples, and are not intended to limit the scope, applicability, operation, or configuration of the disclosure in any way. It will be further appreciated by a person skilled in the art that numerous variations and/or modifications may be made to one or more of the above-described embodiments without departing from the spirit or scope of the disclosure as broadly described in the appended claims. The above-described embodiments are, therefore, to be considered in all respects to be illustrative and not restrictive.

1. A computer-implemented method, comprising:
obtaining transaction data of at least one transacting party, the at least one transacting party being one who has initiated a transaction with a first client, wherein at least one of the transaction data of the at least one transacting party relates to a transaction initiated by the at least one transacting party with a second client;
determining, by a computing device, a group of clients based on the transaction data of the at least one transacting party with one or more of the second clients to have clients that are different from each other; and
generating, by a computing device, an indicia, using at least one of the clients in the group, that provides a likelihood that a holder of an account will initiate a transaction with the first client.

2. The method according to claim 1, wherein the holder of the account is the at least one transacting party who has initiated a transaction with the first client.

3. The method according to claim 1, wherein the holder of the account is one other than the at least one transacting party who has initiated a transaction with the first client.

4. The method according to claim 1, wherein at least one of the transaction data of the at least one transacting party relates to a transaction initiated by the at least one transacting party with the first client, wherein determining the group of clients is also based on transaction data of the at least one transacting party with the first client.

5. The method according to claim 1, wherein the indicia is generated based on the transaction data of the holder of the account over a time period; and
wherein the indicia indicates if the holder of the account is likely to initiate a transaction with the first client for a future time period.

6. (canceled)

7. The method according to claim 1, further comprising:
generating another indicia based on transaction data of a holder of another account, the other indicia indicating if the holder of another account is likely to initiate a transaction with the first client; and
ranking the holders of the accounts based on both the generated indicia.

8. (canceled)

9. The method according to claim 1, wherein determining the group of clients based on the transaction data of the at least one transacting party further comprises:
obtaining transaction data of a plurality of holders of accounts in a database, each of the transaction data of the plurality of holders of accounts relating to a transaction initiated by a holder of an account with a client;
generating a group of clients based on the transaction data of the plurality of holders of accounts; and
removing at least one client from the generated group of clients, based on a filtering criteria applied on the transaction data of the plurality of holders, so that the remaining clients are used to generate the indicia that provides the likelihood that a holder of an account will initiate a transaction with the first client.

10. The method according to claim 9, wherein the filtering criteria applied on the transaction data of the plurality of holders comprises:
determining if a client, related to the transaction data of the plurality of holders of accounts, belongs to a group of clients with which a number of holders of accounts transact, the number being one which is above a threshold.

11. The method according to claim 10, wherein the threshold is a predetermined portion of the plurality of holders of accounts in the database.

12. (canceled)

13. The method according to claim 1, wherein at least one of the transaction data of the at least one transacting party relates to a transaction initiated by the at least one transacting party with each of a plurality of clients that are different from the first client.

14. (canceled)

15. (canceled)

16. A server comprising:
at least one processor; and
at least one memory including computer program code;
the at least one memory and the computer program code configured to, with the at least one processor, cause the server at least to:
obtain transaction data of at least one transacting party, the at least one transacting party being one who has initiated a transaction with a first client, wherein at least one of the transaction data of the at least one transacting party relates to a transaction initiated by the at least one transacting party with a second client to have clients that are different from each other;
determine a group of clients based on the transaction data of the at least one transacting party with one or more of the second client; and
generate an indicia, using at least one of the clients in the group, that provides a likelihood that a holder of an account will initiate a transaction with the first client.

17. The server according to claim 16, wherein the holder of the account is the at least one transacting party who has initiated a transaction with the first client.

18. The server according to claim 16, wherein the holder of the account is one other than the at least one transacting party who has initiated a transaction with the first client.

19. The server according to claim 16, wherein at least one of the transaction data of the at least one transacting party relates to a transaction initiated by the at least one transacting party with the first client, wherein determining the group of clients is also based on transaction data of the at least one transacting party with the first client.

20. The server according to claim 16, wherein the indicia is generated based on the transaction data of the holder of the account over a time period; and
wherein the indicia indicates if the holder of the account is likely to initiate a transaction with the first client for a future time period.

21.-23. (canceled)

24. The server according to claim 16, wherein the determination of the group of clients based on the transaction data further comprises:
obtaining transaction data of a plurality of holders of accounts in a database, each of the transaction data of the plurality of holders relating to a transaction initiated by a holder of an account with a client;
generating a group of clients based on the transaction data of the plurality of holders of accounts; and
removing at least one client from the generated group of clients, based on a filtering criteria applied on the transaction data of the plurality of holders, so that the remaining clients are used to generate the indicia that provides the likelihood that a holder of an account will initiate a transaction with the first client.

25. The server according to claim 24, wherein the filtering criteria applied on the transaction data of the plurality of holders of accounts comprises:
determining if a client, related to the transaction data of the plurality of holders of accounts, belongs to a group of clients with which a number of holders of accounts transact, the number being one which is above a threshold.

26. The server according to claim 25, wherein the threshold is a predetermined portion of the plurality of holders of accounts in the database.

27. (canceled)

28. The server according to claim 16, wherein at least one of the transaction data of the at least one transacting party relates to a transaction initiated by the at least one transacting party with each of a plurality of clients that are different from the first client.

29.-31. (canceled)

32. A non-transitory computer-readable storage medium having stored thereon computer program code which, when executed by a processor, causes the processor to:
obtain transaction data of at least one transacting party, the at least one transacting party being one who has initiated a transaction with a first client, wherein at least one of the transaction data of the at least one transacting party relates to a transaction initiated by the at least one transacting party with a second client;
determine a group of clients based on the transaction data of the at least one transacting party with one or more of the second clients to have clients that are different from each other; and
generate an indicia, using at least one of the clients in the group, that provides a likelihood that a holder of an account will initiate a transaction with the first client.

33. (canceled)
